(19) United States
(12) Patent Application Publication
(10) Pub. No.: US 2009/0309970 A1
(43) Pub. Date: Dec. 17, 2009

(54) Vehicle Operation System And Vehicle Operation Method

(75) Inventors: Yohei ISHII, Osaka City (JP); Ken MASHITANI, Neyagawa City (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Osaka (JP)

(21) Appl. No.: 12/478,068

(22) Filed: Jun. 4, 2009

(30) Foreign Application Priority Data
Jun. 4, 2008 (JP) 2008-146835

(51) Int. Cl. H04N 7/18

(52) U.S. Cl. 348/143; 348/E07.085

(57) ABSTRACT

A vehicle operation system has: a shot image acquisition portion acquiring a shot image from an image shooting device mounted on a vehicle; an input portion to which movement information on the vehicle is input; and a display portion displaying an image based on the movement information in a form superimposed on an image based on the shot image. The vehicle operation system operates the vehicle based on the movement information.

This nonprovisional application claims priority under 35 U.S.C. § 119(a) on Patent Application No. 2008-146835 filed in Japan on Jun. 4, 2008, the entire contents of which are hereby incorporated by reference.

### BACKGROUND OF THE INVENTION

1. Field of the Invention

The present invention relates to a vehicle operation system and a vehicle operation method for operating a vehicle by use of an image shot by a camera mounted on the vehicle (hereinafter referred to as a vehicle-mounted camera).

2. Description of Related Art

With increasing awareness of safety in these days, vehicle-mounted cameras have been becoming more and more wide-spread. As one example of a system employing a vehicle-mounted camera, one conventionally proposed system (all-around display system) aims at assisting safe driving through the monitoring of the surroundings of a vehicle by use of a plurality of vehicle-mounted cameras, wherein the images shot by the vehicle-mounted cameras are converted through viewpoint conversion into bird's-eye view images as seen from vertically above the vehicle and the bird's-eye view images are merged together to display a view all around the vehicle. An example of an all-around display image in a case where a truck is fitted with four cameras, one on each of its front, rear, left, and right, is shown in FIGS. 21A and 21B. FIG. 21A is a diagram showing the shooting ranges of the four cameras fitted on the front, rear, left, and right of the truck, where the reference signs 401 to 404 indicate the shooting ranges of the front, left-side, rear, and right-side cameras, respectively. FIG. 21B is a diagram showing an example of an all-around display image obtained from the images shot in the shooting ranges of the cameras in FIG. 21A, where the reference signs 411 to 414 indicate the bird's-eye-view images obtained through viewpoint conversion of the images shot by the front, left-side, rear, and right-side cameras, respectively, and the reference sign 415 indicates the bird's-eye-view image of the truck, i.e., the own vehicle. An all-around display system like this can display a view all around a vehicle without dead spots, and is therefore useful for assisting drivers in checking for safety.

On the other hand, as a parking assist system that assists a driver's operation as in a case where a vehicle is parked in a narrow space, one conventionally proposed system involves remote control of a vehicle. In this system, operations such as going forward, going backward, turning right, and turning left are assigned to push-button switches. Inconveniently, however, the positional and directional relationship between the vehicle and the remote control transmitter held by the operator varies as the vehicle moves, and thus proper operation requires skill.

To mitigate such difficulties of operation, various technologies have conventionally been proposed: one technology involves keeping constant the positional relationship between a remote control transmitter and a vehicle to allow an operator to perform remote control by moving while holding the remote control transmitter; another technology involves recognizing the positional relationship between a remote control transmitter and a vehicle to allow an operator to effect, by pressing a button of the desired direction, movement in that direction irrespective of the orientation of the vehicle.

Conventional parking assist systems thus do realize vehicle operation by use of a remote control transmitter, but require complicated button operation, or movement of the operator himself, proving to be troublesome to the operator.

### SUMMARY OF THE INVENTION

An object of the present invention is to provide a vehicle operation system and a vehicle operation method with enhanced operability.

To achieve the above object, according to one aspect of the invention, a vehicle operation system comprises: a shot image acquisition portion that acquires a shot image from an image shooting device mounted on a vehicle; an input portion to which movement information on the vehicle is input; and a display portion that displays an image based on the movement information in a form superimposed on an image based on the shot image. Here, the vehicle operation system operates the vehicle based on the movement information.

To achieve the above object, according to another aspect of the invention, a vehicle operation method comprises: a shot image acquisition step of acquiring a shot image from an image shooting device mounted on a vehicle; an input step of receiving movement information on the vehicle; and a display step of displaying an image based on the movement information in a form superimposed on an image based on the shot image. Here, the vehicle operation method is a method that operates the vehicle based on the movement information.

### BRIEF DESCRIPTION OF THE DRAWINGS

FIG. 1 is a block diagram showing the configuration of a vehicle operation system according to a first embodiment of the invention.

FIG. 2 is a flow chart showing the processing executed by the vehicle operation system according to the first embodiment of the invention.

FIG. 3 is a diagram showing an example of an all-around display image displayed on the touch panel monitor.

FIG. 4 is a diagram showing the relationship among a camera coordinate system, an image-sensing surface coordinate system, and a world coordinate system.

FIG. 5 is a diagram showing an example of how a start point and an end point of movement are displayed in a form superimposed on an all-around display image.

FIG. 6 is a diagram showing an example of a movement direction arrow and a predicted course line displayed in a form superimposed on an all-around display image.

FIG. 7 is a diagram showing an example of a movement direction arrow and a predicted course line, in a case where they pose a risk of collision, displayed in a form superimposed on an all-around display image.

FIG. 8 is a diagram showing a locus of pen input in an all-around display image displayed on the touch panel monitor.

FIG. 9 is a diagram showing an example of a movement direction arrow and a predicted course line, in a case where they pose no risk of collision, displayed in a form superimposed on an all-around display image.

FIG. 10 is a block diagram showing the configuration of a vehicle operation system according to a second embodiment of the invention.

FIG. 11 is a flow chart showing the processing executed by the vehicle operation system according to the second embodiment of the invention.

FIG. 12 is a flow chart showing an example of a method for detecting a solid object from an image shot by a single-lens camera.

FIG. 13A is a diagram showing a shot image at time point t1.

FIG. 13B is a diagram showing a shot image at time point t2.

FIG. 14 is a diagram showing characteristic points on a shot image and the corresponding movement vectors between time points t1 and t2.

FIG. 15A is a diagram showing a bird's-eye-view image at time point t1.

FIG. 15B is a diagram showing a bird's-eye-view image at time point t2.

FIG. 16 is a diagram showing characteristic points on a bird's-eye-view image and the corresponding movement vectors between time points t1 and t2.

FIG. 17 is a diagram showing camera movement information as expressed in coordinate systems.

FIG. 18 is a diagram showing a frame-to-frame differential image between time points t1 and t2.

FIG. 19 is a diagram showing a binarized image obtained by applying binarization to the differential image of FIG. 18.

FIG. 20 is a diagram showing an image from which a solid object region has been extracted.

FIGS. 21 and 21B are diagrams showing an example of an all-around display image in a case where a truck is fitted with four cameras, one on each of its front, rear, left, and right.

### DETAILED DESCRIPTION OF PREFERRED EMBODIMENTS

Embodiments of the present invention will be described below with reference to the accompanying drawings.

### First Embodiment

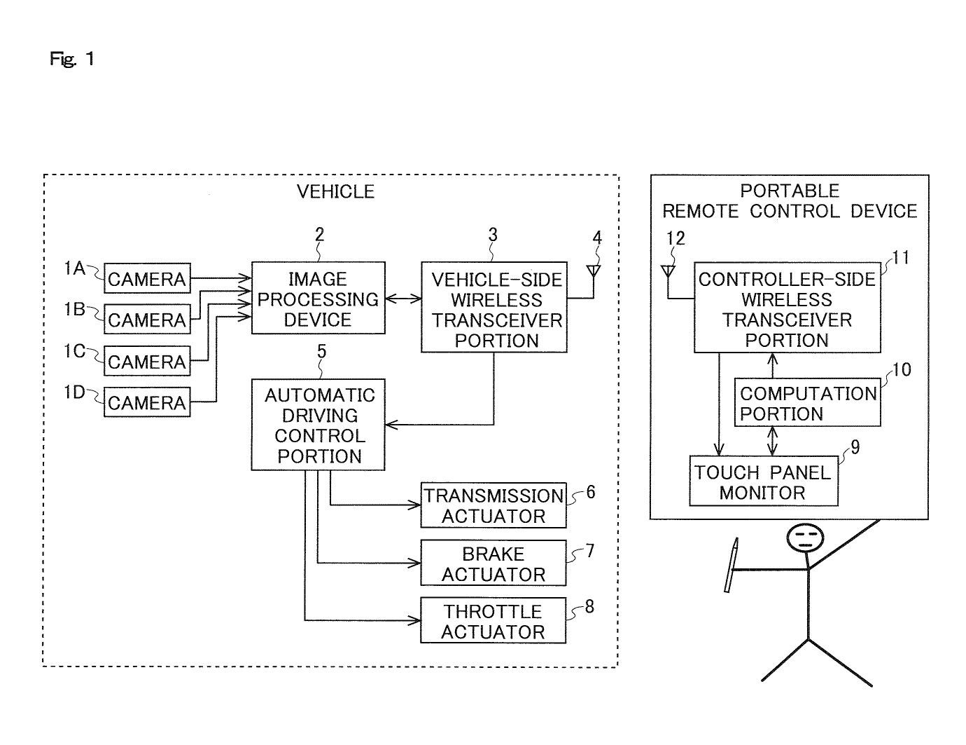

FIG. 1 is a block diagram showing the configuration of a vehicle operation system according to a first embodiment of the invention. The vehicle operation system shown in FIG. 1 comprises the following blocks: an image processing device 2 that generates an all-around display image by use of images shot by four cameras 1A to 1D shooting in the front, left-side, rear, and right-side directions with respect to a vehicle; a vehicle-side wireless transceiver portion 3; a vehicle-side antenna 4; and an automatic driving control portion 5 that, in automatic driving mode, controls a transmission actuator 6, a brake actuator 7, and a throttle actuator 8. All these are provided on the vehicle (hereinafter the vehicle is referred to also as the own vehicle).

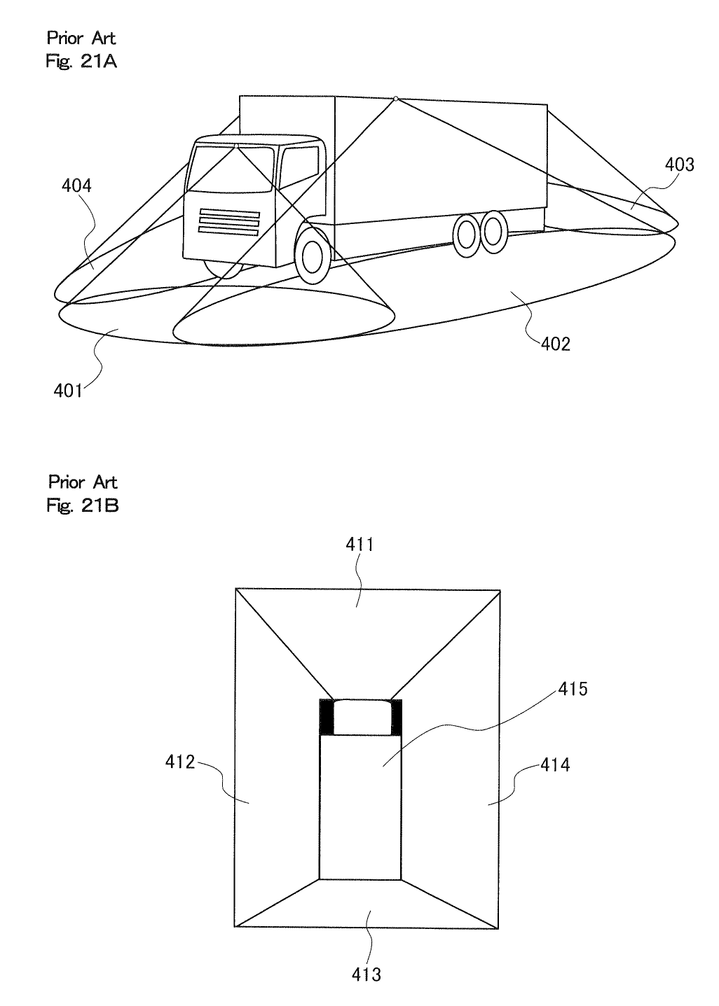

Used as each of the cameras 1A to 1D is a camera employing, for example, a CCD (charge-coupled device) or CMOS (complementary metal oxide semiconductor) image sensor. As in the case shown in FIG. 21A, the cameras 1A to 1D shoot obliquely downward from the positions at which they are respectively fitted on the vehicle.

In automatic driving mode, the transmission actuator 6 actuates an automatic transmission (unillustrated) according to an output signal of the automatic driving control portion 5; in manual driving mode (normal driving mode), the transmission actuator 6 receives from a driving control portion (unillustrated) a torque control signal according to various conditions such as the position of a gearshift lever, the number of engine rotation, the amount of displacement of a gas pedal (accelerator pedal, unillustrated), etc., and actuates the automatic transmission according to the torque control signal. In automatic driving mode, the brake actuator 7 feeds a braking system (unillustrated) with a brake fluid pressure according to an output signal of the automatic driving control portion 5; in manual driving mode, the brake actuator 7 feeds the braking system (unillustrated) with a brake fluid pressure according to an output signal of a brake sensor (unillustrated) detecting the displacement of a brake pedal (unillustrated). In automatic driving mode, the throttle actuator 8 drives a throttle valve (unillustrated) according to an output signal of the automatic driving control portion 5; in manual driving mode, the throttle actuator 8 drives the throttle valve according to an output signal of an accelerator sensor (unillustrated) detecting the displacement of the gas pedal (unillustrated).

The vehicle operation system shown in FIG. 1 further comprises a portable remote control device having a touch panel monitor 9, a computation portion 10, a controller-side wireless transceiver portion 11, and a controller-side antenna 12.

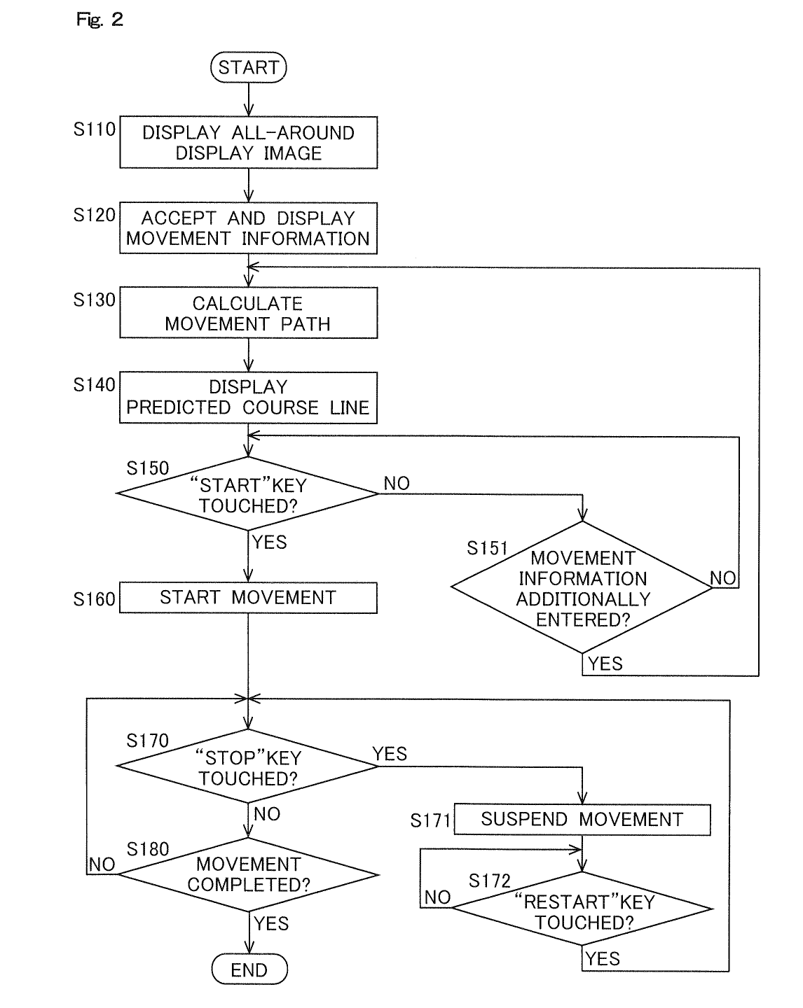

Now, with reference to the flow chart shown in FIG. 2, a description will be given of the processing executed by the vehicle operation system shown in FIG. 1.

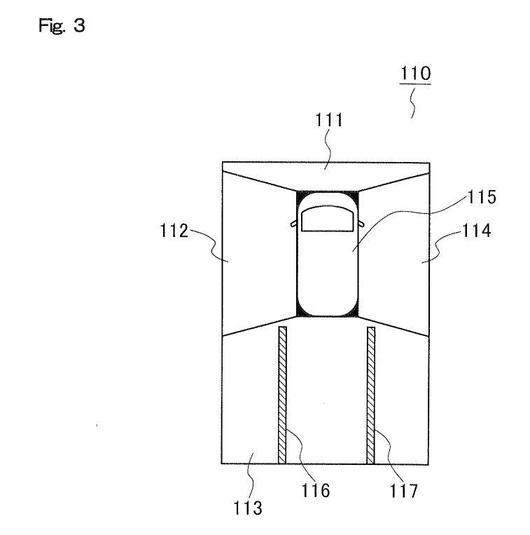

First, at step S110, the image processing device 2 converts the images shot by the four cameras 1A to 1D into bird's-eye-view images by a method described later, and merges the resulting four bird's-eye-view images along with a bird's-eye-view image of the own vehicle previously stored in an internal memory (unillustrated) to generate an all-around display image. The data of the all-around display image is wirelessly transmitted from the vehicle-side wireless transceiver portion 3 via the vehicle-side antenna 4, and is wirelessly received via the controller-side antenna 12 by the controller-side wireless transceiver portion 11, so that the all-around display image is displayed on the screen of the touch panel monitor 9. An example of display on the touch panel monitor 9 is shown in FIG. 3. In FIG. 3, the reference signs 111 to 114 indicate the bird's-eye-view images obtained through viewpoint conversion of the images shot by the cameras 1A to 1D, respectively, which shoot in the front, front, left-side, rear, and right-side directions, respectively, with respect to the own vehicle; the reference sign 115 indicates the bird's-eye-view image of the own vehicle; hatched line segments 116 and 117 indicate a first and a second white line drawn parallel to each other on a road surface appearing within the all-around display image 110.

Now, a method for generating a bird's-eye-view image by perspective projection conversion will be described with respect to FIG. 4.

FIG. 4 shows the relationship among a camera coordinate system XYZ, a camera image-sensing surface S coordinate system X_{bu}Y_{bu}, and a world coordinate system X_{w}Y_{w}Z_{w} including a two-dimensional ground coordinate system X_{w}Z_{w}. The coordinate system X_{bu}Y_{bu} is the coordinate system in which a shot image is defined.

The camera coordinate system XYZ is a three-dimensional coordinate system having, as its coordinate axes, X, Y, and Z axes. The image-sensing surface S coordinate system X_{bu}Y_{bu} is a two-dimensional coordinate system having, as its coordinate axes, X_{bu} and Y_{bu} axes. The two-dimensional ground coordinate system X_{w}Z_{w} is a two-dimensional coordinate system having, as its coordinate axes, X_{w} and Z_{w} axes. The world coordinate system Y_{w}Y_{w}Z_{w} is a three-dimensional coordinate system having, as its coordinate axes, X_{w}, Y_{w}, and Z_{w} axes.

In the following description, the camera coordinate system XYZ, the image-sensing surface S coordinate system X_{bu}Y_{bu}, the two-dimensional ground coordinate system X_{w}Z_{w}, and the world coordinate system Y_{w}Y_{w}Z_{w} are sometimes abbreviated to the camera coordinate system, the image-sensing surface S coordinate system, the two-dimensional ground coordinate system, and the world coordinate system, respectively.

The camera coordinate system XYZ has an origin O at the optical center of the camera, with the Z axis running in the optical-axis direction, the X axis running in the direction perpendicular to the Z axis and parallel to the ground, and the Y axis running in the direction perpendicular to both the Z and X axes. The image-sensing surface S coordinate system X_{bu}Y_{bu} has an origin at the center of the image-sensing surface S, with the X_{bu} axis running in the lateral direction of the image-sensing surface S, and the Y_{bu} axis running in the longitudinal direction of the image-sensing surface S.

The world coordinate system Y_{w}Y_{w}Z_{w} has an origin O_{w} at the intersection between the vertical line (plumb line) passing through the origin O of the camera coordinate system XYZ and the ground, with the Y_{w} axis running in the direction perpendicular to the ground, the X_{w} axis running in the direction parallel to the X axis of the camera coordinate system XYZ, and the Z_{w} axis running in the direction perpendicular to both the X_{w} and Y_{w} axes.

The amount of the translation between the X_{w} and X axes is h, and the direction of the translation is vertical (in the direction of a plumb line). The magnitude of the obtuse angle formed between the Z_{w} and Z axes is equal to that of the inclination angle Θ. The values of h and Θ are previously set with respect to each of the cameras 1A to 1D and fed to the image processing device 2.

The coordinates of a pixel in the camera coordinate system XYZ are represented by (x, y, z). The symbols x, y, and z represent X-, Y-, and Z-axis components, respectively, in the camera coordinate system XYZ. The coordinates of a pixel in the world coordinate system Y_{w}Y_{w}Z_{w} are represented by (x_{w}, y_{w}, z_{w}). The symbols x_{w}, y_{w}, and z_{w} represent X_{w}-, Y_{w}-, and Z_{w}-axis components, respectively, in the world coordinate system Y_{w}Y_{w}Z_{w}. The coordinates of a pixel in the two-dimensional coordinate system X_{w}Z_{w} are represented by (x_{w}, z_{w}). The symbols x_{w} and z_{w} represent X_{w}- and Z_{w}-axis components, respectively, in the two-dimensional coordinate system X_{w}Z_{w}, which is to say that they represent X_{w}- and Z_{w}-axis components in the world coordinate system Y_{w}Y_{w}Z_{w}. The coordinates of a pixel in the image-sensing surface S coordinate system X_{bu}Y_{bu} are represented by (x_{bu}, y_{bu}). The symbols x_{bu} and y_{bu} represent X_{bu}- and Y_{bu}-axis components, respectively, in the image-sensing surface S coordinate system X_{bu}Y_{bu}.

Conversion between coordinates (x, y, z) in the camera coordinate system XYZ and coordinates (x_{w}, y_{w}, z_{w}) in the world coordinate system Y_{w}Y_{w}Z_{w} is expressed by formula (1) below.

$$[ \begin{matrix}x \\ y \\ z\end{matrix} ] = [ \begin{matrix}1 & 0 & 0 \\ 0 & cos Θ & - sin Θ \\ 0 & sin Θ & cos Θ\end{matrix} ] \{ [ \begin{matrix}{x}_{w} \\ {y}_{w} \\ {z}_{w}\end{matrix} ] + [ \begin{matrix}0 \\ h \\ 0\end{matrix} ] \} \qquad ( 1 )$$

Let the focal length of the camera be F. Then, conversion between coordinates (x_{bu}, y_{bu}) in the image-sensing surface S coordinate system X_{bu}Y_{bu} and coordinates (x, y, z) in the camera coordinate system XYZ is expressed by formula (2) below.

$$[ \begin{matrix}{x}_{bu} \\ {y}_{bu}\end{matrix} ] = [ \begin{matrix}F \frac{x}{z} \\ F \frac{y}{z}\end{matrix} ] \qquad ( 2 )$$

Formulae (1) and (2) above give formula (3) below, which expresses conversion between coordinates (x_{bu}, y_{bu}) in the image-sensing surface S coordinate system X_{bu}Y_{bu} and coordinates (x_{w}, z_{w}) in the two-dimensional ground coordinate system X_{w}Z_{w}.

$$[ \begin{matrix}{x}_{bu} \\ {y}_{bu}\end{matrix} ] = [ \begin{matrix}\frac{{Fx}_{w}}{h sin Θ + {z}_{w} cos Θ} \\ \frac{( h cos Θ - {z}_{w} sin Θ ) F}{h sin Θ + {z}_{w} cos Θ}\end{matrix} ] \qquad ( 3 )$$

Also defined, though not shown in FIG. 4, is a bird's-eye-view coordinate system XₐᵤYₐᵤ, which is a coordinate system for a bird's-eye-view image. The bird's-eye-view coordinate system XₐᵤYₐᵤ is a two-dimensional coordinate system having, as its coordinate axes, Xₐᵤ and Yₐᵤ axes. The coordinates of a pixel in the bird's-eye-view image coordinate system XₐᵤYₐᵤ are represented by (xₐᵤ, yₐᵤ). A bird's-eye-view image is represented by the pixel signals of a plurality of pixels in a two-dimensional array, and the position of each pixel on a bird's-eye-view image is represented by coordinates (xₐᵤ, yₐᵤ). The symbols xₐᵤ and yₐᵤ represent Xₐᵤ- and Yₐᵤ-axis components, respectively, in the bird's-eye-view image coordinate system XₐᵤYₐᵤ.

A bird's-eye-view image is one obtained by converting a shot image—an image obtained by actual shooting by a camera—into an image as seen from the viewpoint of a virtual camera (hereinafter referred to as the virtual viewpoint). More specifically, a bird's-eye-view image is one obtained by converting a shot image into an image as seen when one looks vertically down on the ground surface. This type of image conversion is generally called viewpoint conversion.

The plane on which the two-dimensional coordinate system X_{w}Z_{w} is defined and which thus coincides with the ground surface is parallel to the plane on which the bird's-eye-view image coordinate system XₐᵤYₐᵤ is defined. Accordingly, projection from the two-dimensional coordinate system X_{w}Z_{w} onto the bird's-eye-view image coordinate system XₐᵤYₐᵤ of the virtual camera is achieved by parallel projection. Let the height of the virtual camera (i.e., the height of the virtual viewpoint) be H. Then, conversion between coordinates (x_{w}, z_{w}) in the two-dimensional coordinate system X_{w}Z_{w} and coordinates (xₐᵤ, yₐᵤ) in the bird's-eye-view image coordinate system XₐᵤYₐᵤ is expressed by formula (4) below. The height H of the virtual camera is previously set. Then, modifying formula (4) gives formula (5) below.

$$\begin{matrix}[ \begin{matrix}{x}_{au} \\ {y}_{au}\end{matrix} ] = \frac{F}{H} [ \begin{matrix}{x}_{w} \\ {z}_{w}\end{matrix} ] & ( 4 ) \\ [ \begin{matrix}{x}_{w} \\ {z}_{w}\end{matrix} ] = \frac{H}{F} [ \begin{matrix}{x}_{au} \\ {y}_{au}\end{matrix} ] & ( 5 )\end{matrix}$$

Substituting formula (5) thus obtained in formula (3) above gives formula (6) below.

$$[ \begin{matrix}{x}_{bu} \\ {y}_{bu}\end{matrix} ] = [ \begin{matrix}\frac{{FHx}_{au}}{Fh sin Θ + {Hy}_{au} cos Θ} \\ \frac{F ( Fh cos Θ - {Hy}_{au} sin Θ )}{Fh sin Θ + {Hy}_{au} cos Θ}\end{matrix} ] \qquad ( 6 )$$

Formula (6) above gives formula (7) below, which expresses conversion from coordinates (x_{bu}, y_{bu}) in the projection surface S coordinate system X_{bu}Y_{bu} to coordinates (xₐᵤ, yₐᵤ) in the bird's-eye-view image coordinate system XₐᵤYₐᵤ.

$$[ \begin{matrix}{x}_{au} \\ {y}_{au}\end{matrix} ] = [ \begin{matrix}\frac{{x}_{bu} ( Fh sin Θ + {Hy}_{au} cos Θ )}{FH} \\ \frac{Fh ( F cos Θ - {y}_{bu} sin Θ )}{H ( F sin Θ + {y}_{bu} cos Θ )}\end{matrix} ] \qquad ( 7 )$$

Since coordinates (x_{bu}, y_{bu}) in the projection surface S coordinate system X_{bu}Y_{bu} are, as they are, coordinates on the projected image, by use of formula (7) above, a shot image can be converted into a bird's-eye-view image.

Specifically, by converting the coordinates (x_{bu}, y_{bu}) of each pixel of a shot image into coordinates (xₐᵤ, yₐᵤ) in the bird's-eye-view image coordinate system, it is possible to generate a bird's-eye-view image. The bird's-eye-view image is composed of pixels arrayed in the bird's-eye-view coordinate system.

In practice, in advance, table data indicating the correspondence between the coordinates (x_{bu}, y_{bu}) of the individual pixels on a shot image and the coordinates (xₐᵤ, yₐᵤ) of the individual pixels on a bird's-eye-view image is created according to formula (7), and is previously stored in a memory (unillustrated). Then, by use of the table data, perspective projection conversion is performed to convert a shot image into a bird's-eye-view image. Needless to say, instead, it is also possible to perform perspective projection conversion calculations every time a shot image is acquired, to generate a bird's-eye-view image. Although the above description deals with a method of generating a bird's-eye-view image by perspective projection conversion, it is also possible, instead of generating a bird's-eye-view image from a shot image by perspective projection conversion, to generate a bird's-eye-view image from a shot image by planar projection conversion.

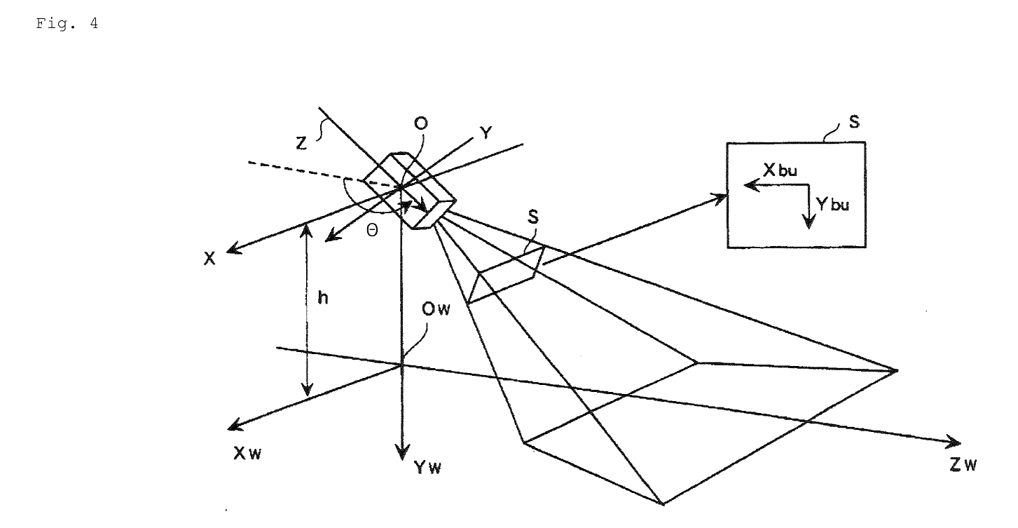

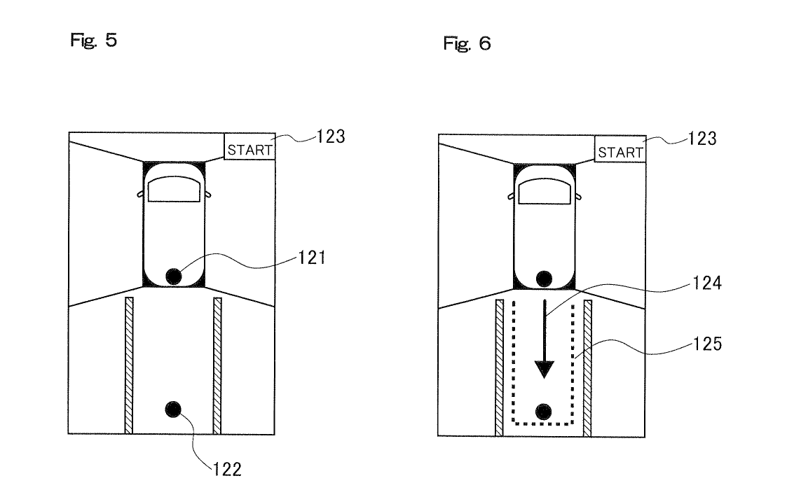

Subsequently to step S110 (see FIG. 2), at step S120, movement information is entered by pen input on the touch panel monitor 9. When, on the all-around display image 110 shown in FIG. 3, a start point and an end point of movement is specified in this order by pen input, then, as shown in FIG. 5, the start point 121 and the end point 122 of movement are displayed superimposed on the all-around display image. At this time, a “start” key 123 is also displayed on the screen of the touch panel monitor 9. FIG. 5 shows an example of display in a case of backward parking.

Subsequently to step S120, at step S130, the computation portion 10 calculates a movement path of the own vehicle based on the pen-input movement information. Then, according to the result of calculation by the computation portion 10, the touch panel monitor 9 displays, as shown in FIG. 6, an arrow 124 indicating the movement direction along with a broken like as a predicted course line 125 indicating the vehicle width as well, in a form superimposed on the display shown in FIG. 5 (step S140). The computation portion 10 has vehicle width data of the own vehicle previously stored in an internal memory (unillustrated).

The operator who did the pen input then confirms the predicted course line 125 and, if he sees no fear of collision or the like, he touches the “start” key 123. Thus, subsequently to step S140, at step S150, the touch panel monitor 9 checks whether or not there is a touch on the “start” key 123.

If there is no touch on the “start” key 123 (NO at step S150), the touch panel monitor 9 checks whether or not there is additional entry of movement information by pen input on the touch panel monitor 9 (step S151). If there is no additional entry of movement information, a return is made to step S150; if there is additional entry of movement information, a return is made to step S130, where a new movement path is calculated with consideration given to the additionally entered movement information as well.

On the other hand, if there is a touch on the “start” key 123 (YES at step S150), movement is started (step S160). Specifically, movement is started through the following procedure. First, information that there has been a touch on the “start” key 123 is conveyed from the touch panel monitor 9 to the computation portion 10; moreover, the data of the movement path calculated at step S3 and an execute command are output from the computation portion 10 to the controller-side wireless transceiver portion 11, are wirelessly transmitted from the controller-side wireless transceiver portion 11 via the controller-side antenna 12, are wirelessly received via the vehicle-side antenna 4 by the vehicle-side wireless transceiver portion 3, and are fed to the automatic driving control portion 5. Subsequently, according to the execution command, the automatic driving control portion 5, referring to specifications data of the own vehicle previously stored in an internal memory (unillustrated), creates an automatic driving program based on the movement path data, and controls the transmission actuator 6, the brake actuator 7, and the throttle actuator 8 according to the automatic driving program.

Preferably, during movement, instead of the “start” key, a “stop” key is displayed so that, whenever there is an increased fear of collision or the like during movement as resulting from a person suddenly rushing out, the own vehicle can be readily stopped by the operator touching the “stop” key by pen input. In this case, a touch on the “stop” key causes the “restart” key to be displayed instead of the “stop” key, so as to allow the operator to restart movement by touching the “restart” key.

Subsequently to step S160, at step S170, the touch panel monitor 9 checks whether or not there is a touch on the “stop” key.

If there is a touch on the “stop” key (YES at step S170), the automatic driving control portion 5 temporarily stops the execution of the automatic driving program (step S171). This suspends movement. Subsequently to step S171, at step S172, the touch panel monitor 9 checks whether or not there is a touch on the “restart” key, and if there is a touch on the “restart” key, a return is made to step S170.

If there is no touch on the “stop” key (NO at step S170), the automatic driving control portion 5 checks whether or not the execution of the automatic driving program has been completed and thus movement has been completed (step S180). If movement has not been completed, a return is made to step S170; if movement has been completed, the operation flow is ended.

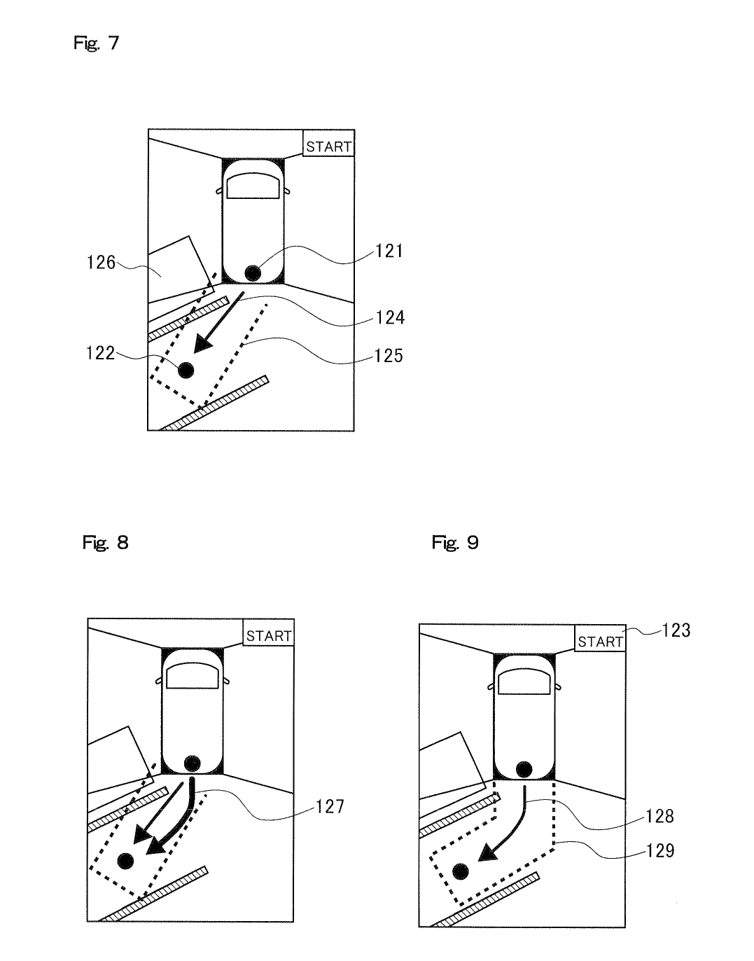

An example where, as distinct from in the case shown in FIG. 6, collision needs to be avoided is shown in FIG. 7. In a parking lot or the like, in a case where another vehicle 126 is parked in an adjacent parting space, if the own vehicle moves straight backward along a movement path suggested by specified start and end points 121 and 122 without turning as shown in FIG. 7, it will collide with the other vehicle 126.

The operator can easily recognize the risk by the movement direction arrow 124 and the predicted course line 125 displayed first at step S140 in FIG. 2 (see FIG. 7). In a case like this where collision needs to be avoided, the operator enters additional movement information, like the locus 127 of pen input in FIG. 8, by pen input (YES at step S151 in FIG. 2) to specify the desired movement path, so that a new movement path is calculated and a new movement direction arrow 128 and a new predicted course line 129 are displayed as in FIG. 9. The length of the locus 127 of pen input, i.e., the magnitude of the direction vector of pen input, may be associated with the speed or amount of movement of the own vehicle, so as to be handled as an item of movement information. When the operator confirms the newly displayed predicted course line 129 to be adequate, he then touches the “start” key 123. This starts movement along the new movement path.

With the vehicle operation system according to the first embodiment of the invention, the operator can check for safety by viewing the display on the touch panel monitor 9 and then commands the start of movement. The vehicle operation system according to the first embodiment of the invention permits the own vehicle to be operated from outside it, and thus helps reduce the trouble of getting into and out of the vehicle, for example, at the time of driving it into and out of a garage having a gate. Also, for example, in a case where an operator not very good at driving needs to drive on a narrow road, he can move the own vehicle easily by specifying and selecting an adequate driving path on the touch panel monitor 9 from inside the vehicle.

### Second Embodiment

A vehicle operation system according to a second embodiment of the invention is, compared with the one according to the first embodiment of the invention, additionally provided with an obstacle detection capability, so as to be capable of automatic stopping and automatic movement path recalculation on detection of an obstacle in the surroundings.

In a case as shown in FIG. 6, since there is no obstacle in the movement path, no notable differences arise between the vehicle operation system according to the first embodiment of the invention and the one according to the second embodiment of the invention. In a case as shown in FIG. 7, however, with the vehicle operation system according to the first embodiment of the invention, the operator needs to weigh the risk of collision by viewing the image. By contrast, with the vehicle operation system according to the second embodiment of the invention, even if the operator notices no risk of collision, an obstacle that poses a risk of collision can be detected automatically.

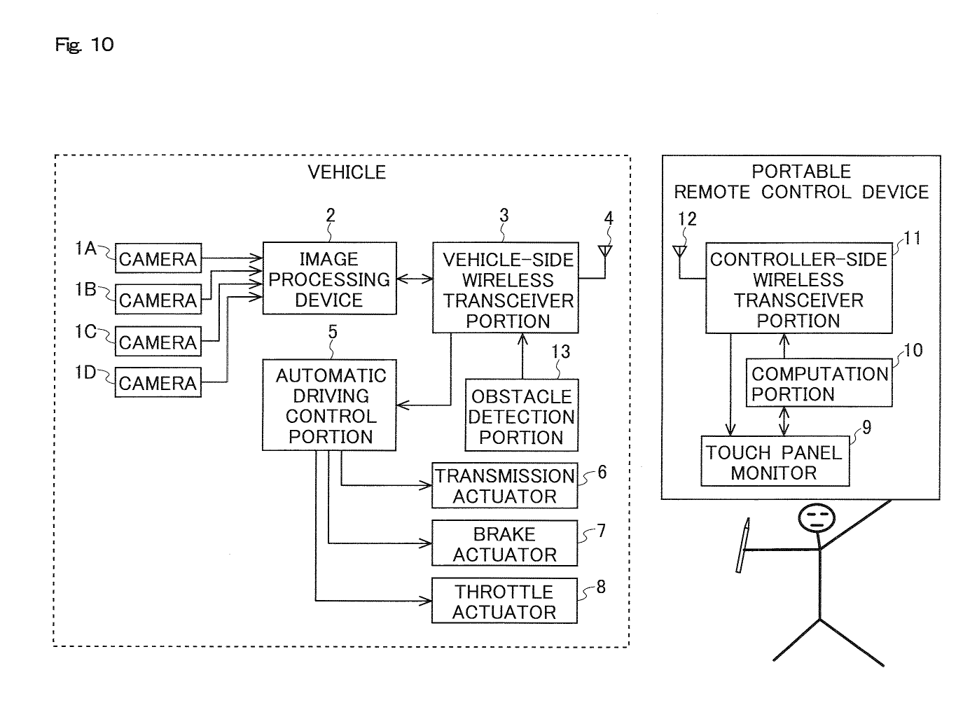

FIG. 10 is a block diagram showing the configuration of a vehicle operation system according to the second embodiment of the invention. In FIG. 10, such parts as are found also in FIG. 1 are identified by common reference symbols, and no detailed description of such parts will be repeated. The vehicle operation system shown in FIG. 10 differs from the vehicle operation system according to the first embodiment of the invention in that it additionally comprises an obstacle detection portion 13. The obstacle detection portion 13 is provided on the own vehicle.

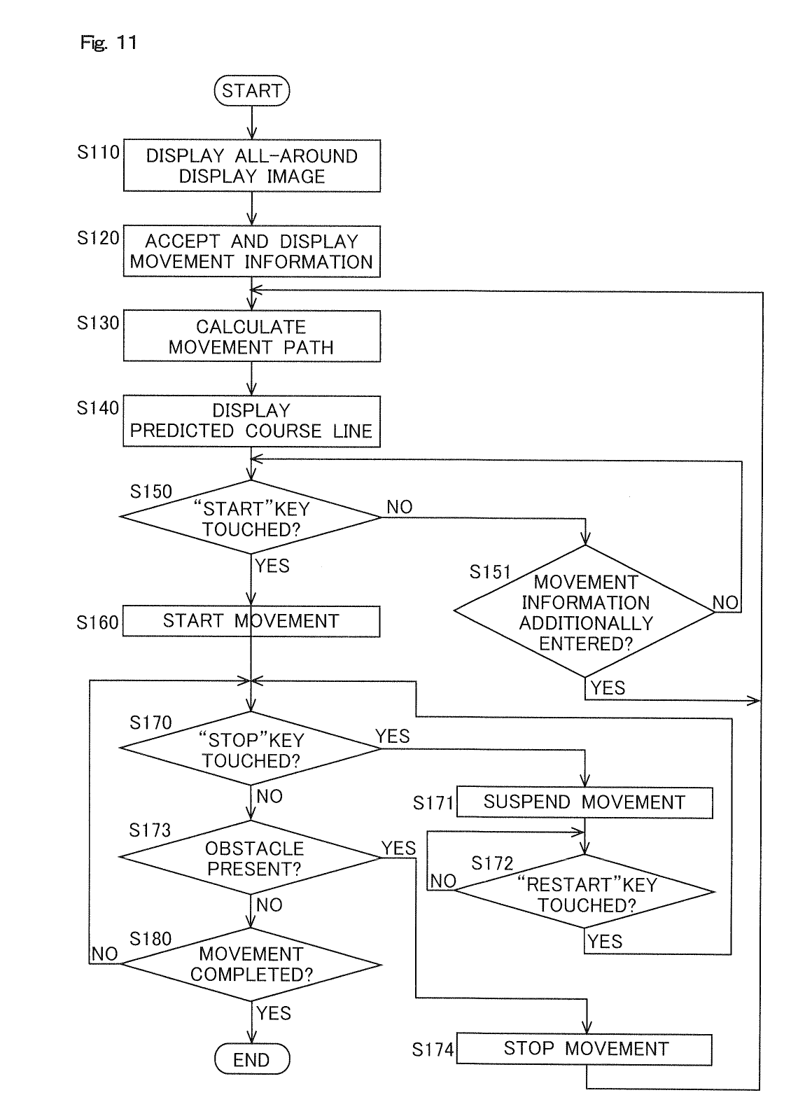

A flow chart related to the processing executed by the vehicle operation system shown in FIG. 10 is shown in FIG. 11. In FIG. 11, such steps as are found also in FIG. 2 are identified by common reference symbols, and no detailed description of such steps will be repeated.

The flow chart shown in FIG. 11 differs from that shown in FIG. 2 in that it additionally includes steps S173 and S174.

Suppose that, in a case as shown FIG. 7 described above, the operator notices no risk of collision in the state of FIG. 7, and starts movement at step S160. In this case, immediately after the own vehicle starts to move (backward), the vehicle 126 parked at the left-hand back of the own vehicle is detected as an obstacle (YES at step S173), and movement is stopped (step S174); then information on the position of the obstacle is output from the obstacle detection portion 13 to the vehicle-side wireless transceiver portion 3, is wirelessly transmitted from the vehicle-side wireless transceiver portion 3 via the vehicle-side antenna 4, is wirelessly received via the controller-side antenna 12 by the controller-side wireless transceiver portion 11, and is fed to the computation portion 10. Based on the information on the position of the obstacle, the computation portion 10 recalculates a movement path (step S130) to calculate one to avoid the obstacle; thus a new movement path is calculated, so that a new movement direction arrow 128 and a new predicted course line 129 as shown in FIG. 9 are displayed. The operator can then check for safety on the new movement path and touch the “start” key 123 once again (step S170).

If no adequate movement path is found by the recalculation after the stop of movement at step S174, information on the movement already made may be saved so that the own vehicle is returned, tracking backward the movement path up to the moment, to the position at which the operator previously touched the “start” key. This embodiment deals with a case where, after the own vehicle has started to move, movement is stopped on detection of the parked vehicle 126 as an obstacle; instead, in a case where the obstacle detection capability has a wide detection range, the parked vehicle 126 may be detected as an obstacle as early as in the state of FIG. 7, in which case a movement path with no risk of collision with the obstacle can be calculated from the beginning so that a movement direction arrow 128 and a predicted course line 129 as shown in FIG. 9 are displayed.

With the vehicle operation system according to the second embodiment of the invention, even if the operator notices no risk of collision, an obstacle that poses a risk of collision can be detected automatically, and movement can be stopped automatically. In addition, recalculating a movement path, or calculating one from the beginning, by use of the result of detection of an obstacle saves the operator the trouble of specifying a movement path with no risk of collision.

In one possible configuration, the obstacle detection portion 13 comprises a sensor, such as a sonar, a milliwave radar, or a laser radar, and an obstacle region detecting portion that, based on the result of detection by the sensor, detects an obstacle region within the all-around display image. In another possible configuration, the obstacle detection portion 13 comprises an obstacle region detection-directed image processing portion that detects an obstacle region through image processing using the images shot by the cameras fitted on the vehicle. Any of these and other configurations may be used so long as it can detect an obstacle.

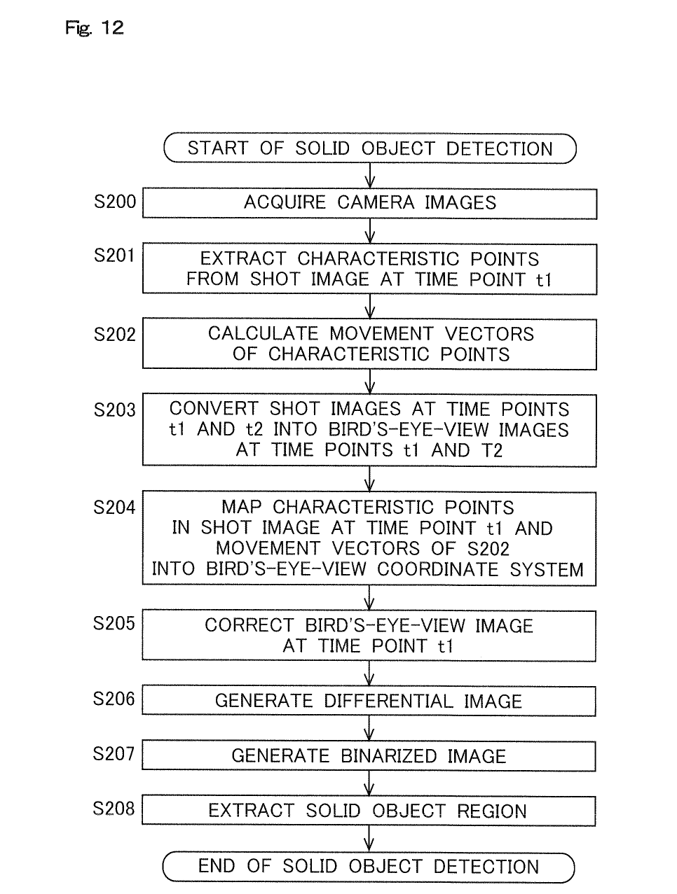

Now, one example of how the obstacle region detection-directed image processing portion mentioned above detects a solid (three-dimensional) object, as one type of obstacle, from images shot by a single-lens camera will be described with reference to the flow chart shown in FIG. 12.

First, images shot by the camera are acquired (step S200). For example, a shot image obtained by shooting at time point t1 (hereinafter referred to simply as the shot image at time point t1) and a shot image obtained by shooting at time point t2 (hereinafter referred to simply as the shot image at time point t2) are acquired. Here, it is assumed that time points t1 and t2 occur in this order, and that a vehicle 4 moves between time points t1 and t2. Accordingly, how a road surface appears changes between time points t1 and t2.

Suppose now that the image 210 shown in FIG. 13A is acquired as the shot image at time point t1, and that the image 220 shown in FIG. 13B is acquired as the shot image at time point t2. Assume also that, at both time points t1 and t2, there appear in the view field of the camera a first and second white line drawn parallel to each other on a road surface and a solid object α, in the shape of a rectangular parallelepiped located between the first and second white lines. In FIG. 13A, hatched line segments 211 and 212 indicate the first and second white lines within the image 210; in FIG. 13B, hatched line segments 221 and 222 indicate the first and second white lines within the image 220. In FIG. 13A, a solid object 213 on the image is the solid object α as appearing within the image 210; in FIG. 13B, a solid object 223 on the image is the solid object α as appearing within the image 220.

Subsequently to step S200, at step S201, characteristic points are extracted from the shot image at time point t1. Characteristic points are points that are distinguishable from the points around them and that are easy to track. Characteristic points can be automatically extracted by use of a well-known characteristic point extractor (unillustrated) that detects pixels that exhibit a notable change in density in the horizontal and vertical directions. Examples of characteristic point extractors include the Harris corner detector and the SUSAN corner detector. To be extracted as characteristic points are, for example, the following: an intersection between or an end point of white lines drawn on the road surface; a stain or crack on the road surface; an end of or a stain on a solid object.

Subsequently to step S201, at step S202, the shot image at time point t1 and the shot image at time point t2 are compared and, by the well-known block matching method or gradient method, an optical flow in the coordinate system of shot images between the time points t1 and t2 is found. An optical flow is an aggregate of a plurality of movement vectors, and the optical flow found at step S202 includes the movement vectors of the characteristic points extracted at step S201. Between two images, the movement vector of a given characteristic point represents the direction and magnitude of the movement of that given characteristic point between the two images. A movement vector is synonymous with a motion vector.

At step S201, a plurality of characteristic points are extracted, and at step S202, the movement vectors of the characteristic points are found respectively. Here, for the sake of concrete description, two of those characteristic points are taken as of interest. The two characteristic points comprise a first and a second characteristic point.

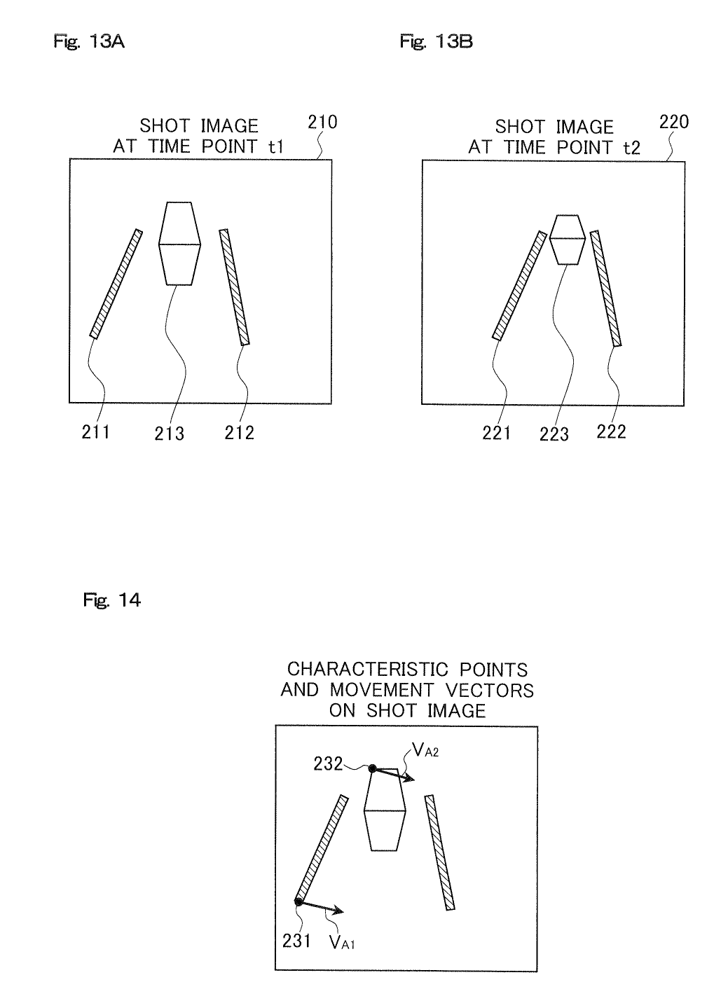

FIG. 14 shows the first and second characteristic points extracted from the shot image at time point t1, as superimposed on the shot image at time point t1. In FIG. 14, points 231 and 232 are the first and second characteristic points extracted from the shot image at time point t1. The first characteristic point is an end point of the first white line, and the second characteristic point is an end point of the solid object a which is located on the top surface of the solid object α. In the shot image at time point t1 shown in FIG. 14, the movement vector V_{A1} of the first characteristic point and the movement vector V_{A2} of the second characteristic point are shown as well. The starting point of the movement vector V_{A1} coincides with the point 231, and the starting point of the movement vector V_{A2} coincides with the point 232.

Subsequently to step S202, at step S203, the shot images at time points t1 and t2 are converted into bird's-eye-view images respectively. The bird's-eye-view image conversion here is the same as described in connection with the first embodiment, and therefore it is preferable that the bird's-eye-view image conversion function be shared between the image processing device 2 and obstacle region detection-directed image processing portion.

The bird's-eye-view images based on the shot images at time points t1 and t2 are called the bird's-eye-view images at time points t1 and t2, respectively. Images 310 and 320 shown in FIGS. 15A and 15B are the bird's-eye-view images at time points t1 and t2 based on the images 210 and 220 in FIGS. 13A and 13B, respectively. In FIG. 15A, hatched line sections 311 and 312 indicate the first and second white lines within the image 310; in FIG. 15B, hatched line sections 321 and 322 indicate the first and second white lines within the image 320. In FIG. 15A, a solid object 313 on the image is the solid object α as appearing within the image 310; in FIG. 15B, a solid object 323 on the image is the solid object α as appearing within the image 320.

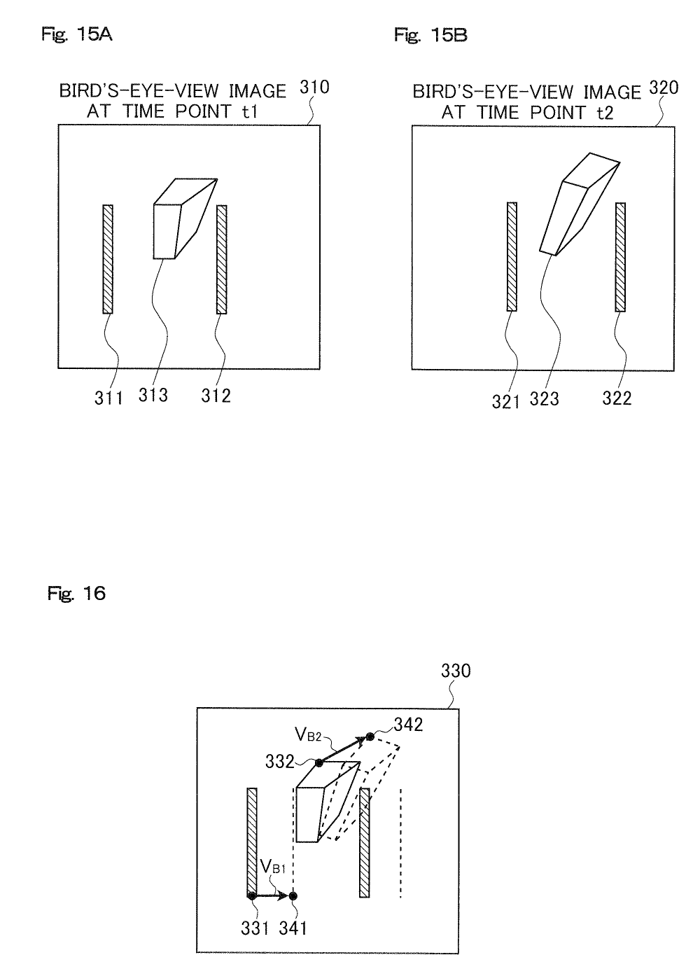

Subsequently to step S203 (see FIG. 12), at step S204, the characteristic points extracted from the shot image at time point t1 at step S201 and the movement vectors calculated at step S202 are mapped (in other words, projected) into the bird's-eye-view coordinate system. FIG. 16 is a diagram showing the so mapped characteristic points and movement vectors, as superimposed on the image 330 having the bird's-eye-view images at time points t1 and t2 laid together. It should however be noted that, in FIG. 16, to avoid complicated illustration, the first and second white lines in the bird's-eye-view image at time point t2 are indicated by broken lines, and the exterior shape of the solid object a in the bird's-eye-view image at time point t2 is indicated by waved lines.

In FIG. 16, points 331 and 332 are the first and second characteristic points, respectively, at time point t1 as mapped into the bird's-eye-view coordinate system. In FIG. 16, the vectors V_{B1} and V_{B2} are the movement vectors of the first and second characteristic points, respectively, as mapped into the bird's-eye-view coordinate system. The starting point of the movement vector V_{B1} coincides with the point 331, and the starting point of the movement vector V_{B2} coincides with the point 332. Points 341 and 342 are the ending points of the movement vectors V_{B1} and V_{B2}, respectively.

Subsequently to step S204, at step S205, the bird's-eye-view image at time point t1 is corrected by use of information (hereinafter referred to as camera movement information) on the movement of the camera that accompanies the movement of the vehicle. Vehicle movement information is obtained, for example, in the following manner.

When the coordinates of a given ground-associated characteristic point as appearing in the bird's-eye-view images at time points t1 and t2 are represented by (x₁, y₁) and (x₂, y₂), respectively, the movement vector with respect to that given ground-associated characteristic point is given by formula (11) below.

(fₓf_{y})^{T}=(x₂y₂)^{T}−(x₁y₁)^{T} (11)

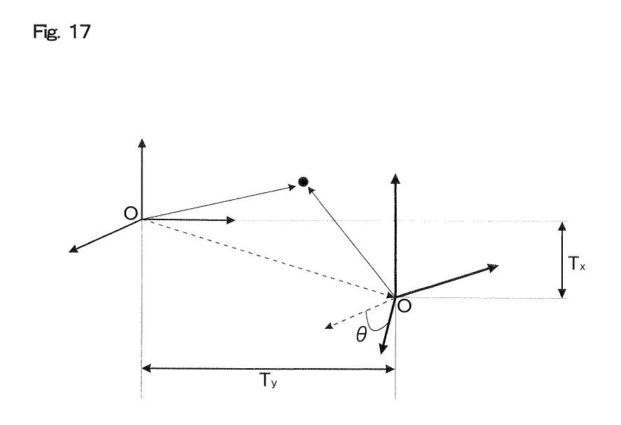

When camera movement information between time points t1 and t2 is expressed in the coordinate systems of FIG. 17, the relationship of a given ground-associated characteristic point as appearing in the bird's-eye-view images at time points t1 and t2 is expressed by formula (12) below. Here, θ represents the rotation angle of the camera 2, and Tₓ and T_{y} represent the amounts of movement of the camera 2 in the x and y directions, respectively.

$$( \begin{matrix}{x}_{2} \\ {y}_{2}\end{matrix} ) = ( \begin{matrix}cos θ & - sin θ \\ sin θ & cos θ\end{matrix} ) ( \begin{matrix}{x}_{1} \\ {y}_{1}\end{matrix} ) + ( \begin{matrix}{T}_{x} \\ {T}_{y}\end{matrix} ) \qquad ( 12 )$$

Here, when θ is negligibly small (as when the vehicle 4 moves at low speed, or when the camera operates at a high frame sampling rate), the approximations cos θ=1 and sin θ=0 are possible. Thus, formula (12) above becomes formula (13) below.

$$( \begin{matrix}{x}_{2} \\ {y}_{2}\end{matrix} ) = ( \begin{matrix}1 & - θ \\ θ & 1\end{matrix} ) ( \begin{matrix}{x}_{1} \\ {y}_{1}\end{matrix} ) + ( \begin{matrix}{T}_{x} \\ {T}_{y}\end{matrix} ) \qquad ( 13 )$$

Substituting formula (11) above in formula (13) above and rearranging the result gives formula (14) below.

θ(y₁−x₁)^{T}−(TₓT_{y})^{T}+(fₓf_{y})^{T}=0 (14)

Here, (fₓ f_{y})^{T} and (y₁−x₁)^{T} are obtained during movement vector calculation, and θ and (Tₓ T_{y})^{T} are unknowns. These unknowns can be calculated according to formula (4) above if information is available on, with respect to two ground-associated characteristic points, their position (x₁ y₁)^{T} and movement vector (fₓ f_{y})^{T}.

Accordingly, when the coordinates of two ground-associated characteristic points in the bird's-eye-view image at time point t1 are represented by (x₁₂ y₁₂)^{T} and (x₁₁ y₁₁)^{T}, and the corresponding movement vectors are represented by (fₓ₁ f_{y1})^{T} and (fₓ₂ f_{y2})^{T}, then formula (14) above gives formulae (15) and (16) below.

θ(y₁₁−x₁₁)^{T}−(TₓT_{y})^{T}+(fₓ₁f_{y1})^{T}=0 (15)

θ(y₁₂−x₁₂)^{T}−(TₓT_{y})^{T}+(fₓ₂f_{y2})^{T}=0 (16)

Taking the difference between formulae (15) and (16) above gives formula (17) below.

$$θ ( \begin{matrix}{y}_{11} - {y}_{12} \\ {x}_{12} - {x}_{11}\end{matrix} ) + ( \begin{matrix}{f}_{x 1} - {f}_{x 2} \\ {f}_{y 1} - {f}_{y 2}\end{matrix} ) = 0 \qquad ( 17 )$$

Formula (17) above gives formulae (18) and (19) below.

θ=(fₓ₂−fₓ₁)/(y₁₁−y₁₂) (18)

θ=(f_{y2}−f_{y1})/(x₁₂−x₁₁) (19)

Thus, by use of the above-noted constraining equations (formulae (15), (16), (18), and (19) above), ground-associated characteristic points are selected through the following procedure:
(i) From the group of characteristic points extracted, two characteristic points are extracted between which the distance is equal to or greater than a predetermined threshold value.
(ii) If there is a difference equal to or greater than a predetermined threshold value between the two characteristic points in the direction and size of their respective movement vectors, a return is made to (i).
(iii) Information on the positions and movement vectors of the two characteristic points are substituted in formulae (18) and (19) above, and the results are calculated as θ₁ and θ₂. If Δθ=|θ₁−θ₂| is greater than a preset threshold value, a return is made to (i).
(iv) The values θ₁ and θ₂ calculated at (iii) are substituted in formulae (15) and (16) above, and the results are calculated as (Tₓ₁ T_{y1})^{T} and (Tₓ₂ T_{y2})^{T}. If (Tₓ₁−Tₓ₂)²+(T_{y1}−T_{y2})² is greater than a preset threshold value, a return is made to (i).
(v) The selected two characteristic points are judged to be ground-associated characteristic points, and the average of the amounts of movement of the two ground-associated characteristic points is taken as camera movement information.

By use of the camera movement information thus obtained, specifically a camera rotation amount θ and camera translation amounts Tₓ and T_{y}, according to formula (13) above, the bird's-eye-view image at time point t1 is converted into a bird's-eye-view image (hereinafter referred to as the reference image) in which the road surface appears the same way as in the bird's-eye-view image at time point t2.

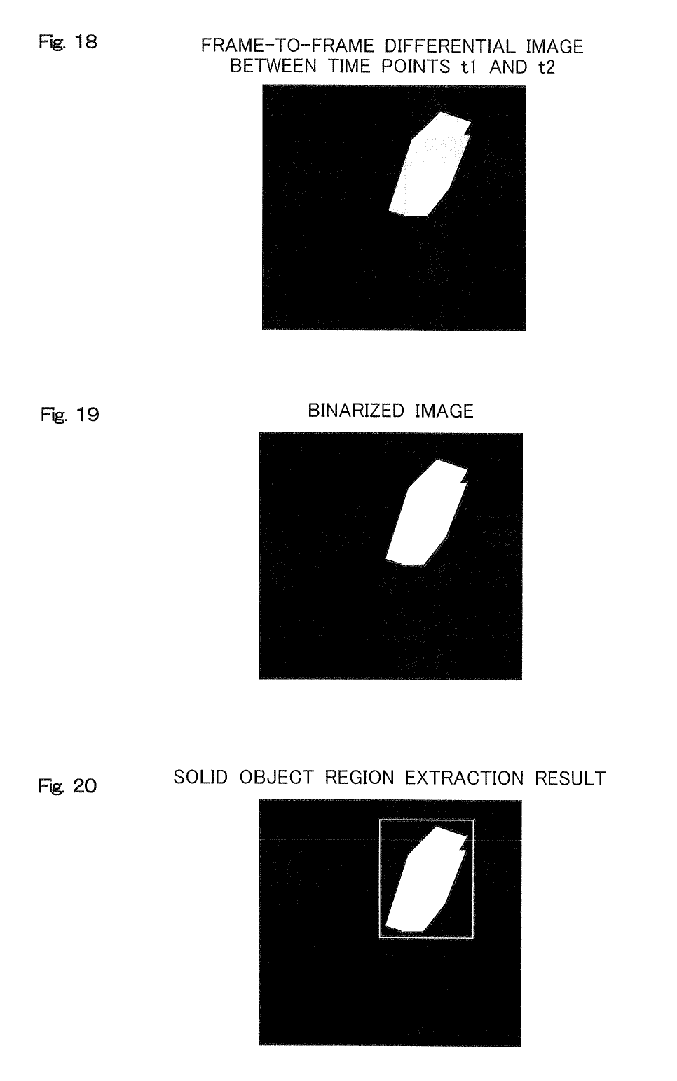

Subsequently to step S205 (see FIG. 12), at step S206, the difference between the reference image and the bird's-eye-view image at time point t2 is taken to obtain a frame-to-frame differential image between time points t1 and t2 as shown in FIG. 18. Then, subsequently to step S206, at step S207, the differential image is binarized with respect to a previously set threshold value. FIG. 19 shows an image after binarization. Further, subsequent to step S207, at step S208, the binarized image in FIG. 19 is subjected to small region elimination and region merging to extract a solid object region. In FIG. 20, the part enclosed in a white-against-black frame is the solid object region extracted. Preferably, the different threshold values used during the processing of the flow chart in FIG. 12 are previously stored in a memory (unillustrated) provided within the obstacle region detection-directed image processing portion.

In solid object detection based on camera image processing, for example, the threshold value for the binarization at step S207 in FIG. 12 can be so set as not to detect as a solid object one with a predetermined height or less. In solid object detection employing a solid object detection sensor, for example, the sensing direction can be so set as not to detect as a solid object one with a predetermined height or less.

The example described above deals with detection of a solid object higher in height than a road surface; however, since methods of obstacle detection by camera image processing and obstacle detection with a sensor can detect a region lower in height than a road surface as well, it is possible, instead of or in addition to detecting a solid object higher in height than a road surface, to detect a region lower in height than a road surface (a region such as a river bank or a gutter lower in height than the road surface on which the own vehicle lies).

### Modifications and Variations

The embodiments described above are in no way meant to limit the invention, which can therefore be additionally provided with, for example, capabilities as described below.

Use can be limited to a particular place (e.g., a parking space at home) by use of location information provided by an RFID (radio frequency identification) system or GPS (global positioning system).

In a case where the own vehicle is an HEV (hybrid electric vehicle), from the viewpoint of easy, high-accuracy automatic driving control, automatic driving is performed not in internal combustion engine mode but in electric motor mode.

In a case of use with the operator in the vehicle, i.e., with the remote control device inside the own vehicle, mode switching between automatic driving mode and manual driving mode (normal driving mode) is permitted only when the own vehicle is stationary.

In the embodiments described above, movement information is entered by pen input on the touch panel monitor; instead, movement information may be entered by finger tip input on the touch panel monitor, or, without use of a touch panel monitor, movement information may be entered by moving a pointer displayed on a display device with a pointing device (e.g., four-way keys).

In the embodiments described above, an all-around display image is obtained by use of a plurality of cameras; instead, an all-around display image may be obtained by use of, for example, a camera system comprising a semi-spherical or conic mirror disposed to face down and a single camera facing vertically up and shooting the mirror image. Instead of an all-around display image, a merged image shot by a single camera or a plurality of cameras and showing part (e.g., only in the rear direction) of the surroundings of the vehicle may be used.

In the embodiments described above, the computation portion 10 is provided on the part of the portable remote control device; instead, it may be provided on the part of the vehicle, in which case the result of computation by the computation portion 10 is wirelessly transmitted to the portable remote control device.

In the embodiments described above, instead of separate internal memories being provided one for each relevant block within the vehicle operation system, a single memory may be shared among a plurality of blocks.

In the embodiments described above, remote control is made possible with the portable remote control device that can be carried out of the own vehicle; instead, a part equivalent to the portable remote control device may be stationarily installed inside the own vehicle to permit operation inside it only. In that case, the wireless transceiver portions and antennas can be omitted. Moreover, in that case, for example, the display device of a car navigation system may be shared as the touch panel monitor of the vehicle operation system according to the invention.

What is claimed is:

1. A vehicle operation system comprising:
a shot image acquisition portion acquiring a shot image from an image shooting device mounted on a vehicle;
an input portion to which movement information on the vehicle is input; and
a display portion displaying an image based on the movement information in a form superimposed on an image based on the shot image,
wherein the vehicle operation system operates the vehicle based on the movement information.

2. The vehicle operation system according to claim 1,
wherein the display portion and the input portion are built with a touch panel monitor.

3. The vehicle operation system according to claim 1, wherein
the image shooting device comprises a plurality of image shooting devices, and
the display portion displays the image based on the movement information in a form superimposed on an image including a merged image having merged together images based on shot images shot by the plurality of image shooting devices.

4. The vehicle operation system according to claim 3,
wherein the display portion displays the image based on the movement information in a form superimposed on an image including a merged image having merged together bird's-eye-view images obtained by viewpoint conversion of shot images shot by the plurality of image shooting devices.

5. The vehicle operation system according to claim 1,
wherein the movement information on the vehicle includes information on a start point and an end point of movement.

6. The vehicle operation system according to claim 5,
wherein the movement information on the vehicle includes information on a movement path and/or a movement speed.

7. The vehicle operation system according to claim 1, wherein
the display portion and the input portion are provided on a remote control device that can be carried out of the vehicle, and
the vehicle operation system further comprises a remote control device-side wireless transceiver portion and a vehicle-side wireless transceiver portion.

8. A vehicle operation method comprising:
a shot image acquisition step of acquiring a shot image from an image shooting device mounted on a vehicle;
an input step of receiving movement information on the vehicle; and
a display step of displaying an image based on the movement information in a form superimposed on an image based on the shot image,
wherein the vehicle operation method is a method that operates the vehicle based on the movement information.

9. The vehicle operation method according to claim 8,
wherein a touch panel monitor is used in the display step and in the input step.

10. The vehicle operation method according to claim 8,
wherein the display step is a step of displaying the image based on the movement information in a form superimposed on an image including a merged image having merged together images based on shot images shot by a plurality of image shooting devices.

11. The vehicle operation method according to claim 10,
wherein the display step is a step of displaying the image based on the movement information in a form superimposed on an image including a merged image having merged together bird's-eye-view images obtained by viewpoint conversion of shot images shot by a plurality of image shooting devices.

12. The vehicle operation method according to claim 8,
wherein the movement information on the vehicle includes information on a start point and an end point of movement.

13. The vehicle operation method according to claim 12,
wherein the movement information on the vehicle includes information on a movement path and/or a movement speed.

14. The vehicle operation method according to claim 8,
wherein the display step and the input step are executed on a remote control device that can be carried out of the vehicle.
